(19) United States
(12) Patent Application Publication
(10) Pub. No.: US 2008/0315695 A1
(43) Pub. Date: Dec. 25, 2008

(54) PRINTED CIRCUIT BOARD FOR A BRUSHLESS MOTOR AND A BRUSHLESS MOTOR USING THE SAME

(75) Inventor: Masahiro YAMADA, KYOTO (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, KYOTO (JP)

(21) Appl. No.: 12/143,142

(22) Filed: Jun. 20, 2008

(30) Foreign Application Priority Data
Jun. 22, 2007 (JP) 2007-165492

(51) Int. Cl. H02K 11/00

(52) U.S. Cl. 310/71; 310/68 B

(57) ABSTRACT

A printed circuit board includes a connection portion connectable to a control unit for driving a brushless motor; position detection element connection wiring lines respectively extending from a plurality of installation places of position detection elements to the connection portion, the position detection elements detecting a magnetic pole position of a rotor magnet of the brushless motor; a wiring line switching portion for switching over a connection state between a specific one of the position detection element connection wiring lines and another wiring line; and a neutral point connection wiring line extending from a neutral point to the wiring line switching portion, the brushless motor having a plurality of coils connected at one end to the neutral point. The specific one of the position detection element connection wiring lines are connectable to the neutral point connection wiring line by means of a conductor in the wiring line switching portion.

### FIELD OF THE INVENTION

The present invention relates to a printed circuit board for brushless motors to which a brushless motor is mounted, and a brushless motor using the same.

### BACKGROUND OF THE INVENTION

A brushless motor needs to employ a control unit that controls rotation of a rotor magnet by specifying a magnetic pole position of the rotor magnet in response to a signal outputted from a position detection element or the like and supplying an electric current to individual coils according to the magnetic pole position thus specified. For this reason, wiring lines for connecting the individual coils and the position detection element to the control unit of the brushless motor are formed in a printed circuit board for brushless motors to which the brushless motor is mounted.

A method for detecting the magnetic pole position of the rotor magnet is properly selected depending on the kind of a product equipped with the brushless motor. Inasmuch as the number of signal transmission lines or the like varies depending on the magnetic pole position detection method, the wiring lines are also differently formed in the printed circuit board for brushless motors according to the position detection method employed.

Examples of the position detection method include a magnetic detection method and a sensorless method. The magnetic detection method refers to a method of detecting a magnetic pole position of a rotor magnet by use of a position detection element that detects the position of a magnetic pole or the magnitude of a magnetic flux density, which is changed with rotation of the rotor magnet. The sensorless method refers to a method of detecting a magnetic pole position of a rotor magnet based on the voltage of a neutral point of coils and the counter-electromotive force generated in the respective coils.

Let us consider a case where Hall elements, one example of the position detection element used in the magnetic detection method, are mounted to the printed circuit board for brushless motors. In this case, a plurality of Hall element connection wiring lines connected to the Hall elements and a plurality of current supply wiring lines, as well as coil wiring lines for supplying electric currents to individual coils, are formed in the printed circuit board for brushless motors. On the other hand, in case of a printed circuit board for brushless motors corresponding to the sensorless method, a neutral point connection wiring line connected to a neutral point of individual coils as well as coil wiring lines are formed in the printed circuit board for brushless motors.

As a prior art example regarding the printed circuit board, Patent Document 1 discloses a printed circuit board capable of changing a wiring line structure. More specifically, if circuit configuration or constants that determine component characteristics cannot be specified during the process of designing a printed circuit board, a printed circuit board is first formed in such a fashion that a wiring line structure can be changed later. According to the later-fixed specification, the connection between wiring lines of the printed circuit board is switched over and components are mounted to the printed circuit board.

(Patent Document 1) Japanese Patent Application Publication No. 2006-261397A

Typically in the manufacture of brushless motors, a brushless motor and a printed circuit board therefor are designed, and prototypes and molds thereof are produced after settling specifications including a position detection method and the like.

The brushless motor mentioned above is suitable for, e.g., a spindle motor of a disk drive apparatus that requires performance such as high speed rotation, long lifespan and so forth. It is, however, the recent trend that the model changing cycle of the disk drive apparatus becomes shorter and shorter. In keeping with this trend, the model changing cycle of the brushless motor for use in the disk drive apparatus tends to become shorter.

As the model changing cycle of the brushless motor is shortened, it becomes hard to secure an ample time for designing the brushless motor and producing a prototype thereof. For the purpose of securing the design and prototype production time, it is the current practice to perform the design and prototype production according to estimated specifications before the final specifications of the brushless motor are settled. For example, if it is not yet decided whether the magnetic detection method using Hall elements or the sensorless method is employed as a position detection method, mold design and prototype production tasks are performed for both kinds of brushless motors that correspond to the respective methods.

Since the mold design and prototype production of the printed circuit board for brushless motors is performed based on more than one kind of estimated specifications as noted above, there is a need to conduct the mold design and prototype production in a plural number of times, which entails a problem of reduced efficiency and increased cost.

### SUMMARY OF THE INVENTION

In view of the above, the present invention provides a printed circuit board for brushless motors capable of adapting itself to either a magnetic detection method or a sensorless method.

In accordance with an aspect of the present invention, there is provided a printed circuit board for a brushless motor including a connection portion connectable to a control unit for driving the brushless motor; a plurality of position detection element connection wiring lines respectively extending from a plurality of installation places of position detection elements to the connection portion, the position detection elements detecting a magnetic pole position of a rotor magnet of the brushless motor; a wiring line switching portion for switching over a connection state between a specific one of the position detection element connection wiring lines and another wiring line; and a neutral point connection wiring line extending from a neutral point to the wiring line switching portion, the brushless motor having a plurality of coils connected at one end to the neutral point. Herein, the specific one of the position detection element connection wiring lines and the neutral point connection wiring line are connectable to each other by means of a conductor in the wiring line switching portion.

It is preferable that, if the position detection elements are mounted to the installation places, the specific one of the position detection element connection wiring lines and the neutral point connection wiring line are not connected to each other in the wiring line switching portion.

Further, it is preferable that, if the position detection elements are not mounted to the installation places, the specific one of the position detection element connection wiring lines and the neutral point connection wiring line are connected to each other by means of the conductor in the wiring line switching portion.

Further, it is preferable that the conductor is a jumper resistor.

Further, it is preferable that the conductor is solder.

Further, it is preferable that the position detection elements are Hall elements.

Further, it is preferable that the neutral point connection wiring line has a width greater than that of each of the position detection element connection wiring lines but smaller than that of a power source connection wiring line connected to the brushless motor.

Further, it is preferable that the wiring line switching portion is arranged radially outwardly of the rotor magnet.

Preferably, there is provided a brushless motor connected to the printed circuit board of the above.

The printed circuit board for brushless motors in accordance with the present invention includes a plurality of position detection element wiring lines for adapting the printed circuit board to a magnetic detection method and a neutral point connection wiring line for adapting the printed circuit board to a sensorless method. In case of using the sensorless method, a specific one of the position detection element wiring lines is connected to the neutral point connection wiring line by use of a conductor such as a jumper resistor or the like so that the voltage of the neutral point of coils can be outputted to a control unit. This allows a single printed circuit board for brushless motors to be adapted to either the magnetic detection method or the sensorless method. Therefore, it is possible to assure increased efficiency and reduced cost when designing and prototyping the printed circuit board for brushless motors.

### BRIEF DESCRIPTION OF THE DRAWINGS

FIG. 1 is a schematic view illustrating a connection state between a brushless motor and a control unit for driving the brushless motor.

FIG. 2 is a schematic view showing a circuit that includes wiring lines formed in a printed circuit board for brushless motors and individual coils.

FIG. 3 is a plan view showing the printed circuit board for brushless motors.

FIG. 4A is an enlarged view illustrating a surrounding region of a wiring line switching portion and FIG. 4B is a view depicting a state that a jumper resistor is mounted to the wiring line switching portion.

FIGS. 5A, 5B and 5C are views showing other examples of the wiring line switching portion.

### DETAILED DESCRIPTION OF THE PREFERRED EMBODIMENTS

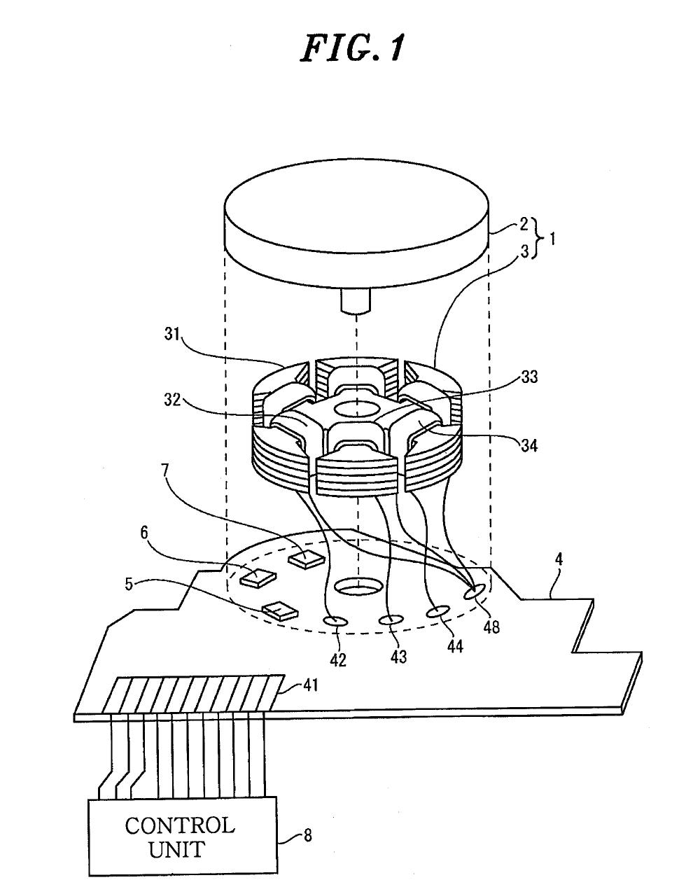

Hereinafter, one or more embodiment of the present invention will be described with reference to the accompanying drawings. FIG. 1 is a schematic view illustrating a connection state between a brushless motor and a control unit for driving the brushless motor. In the connection state shown in FIG. 1, a magnetic detection method is used as a position detection method.

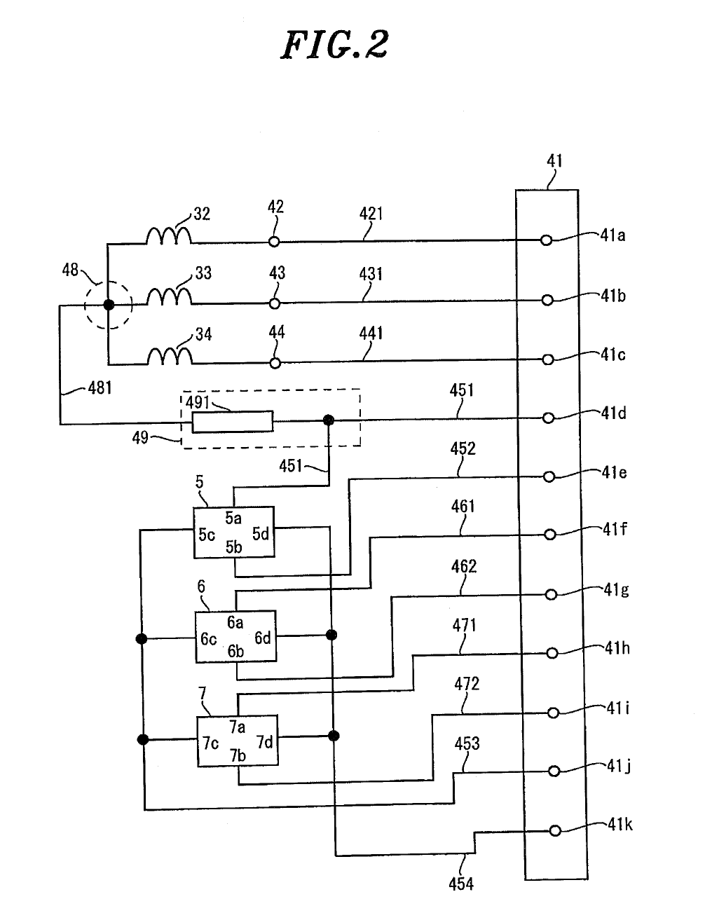

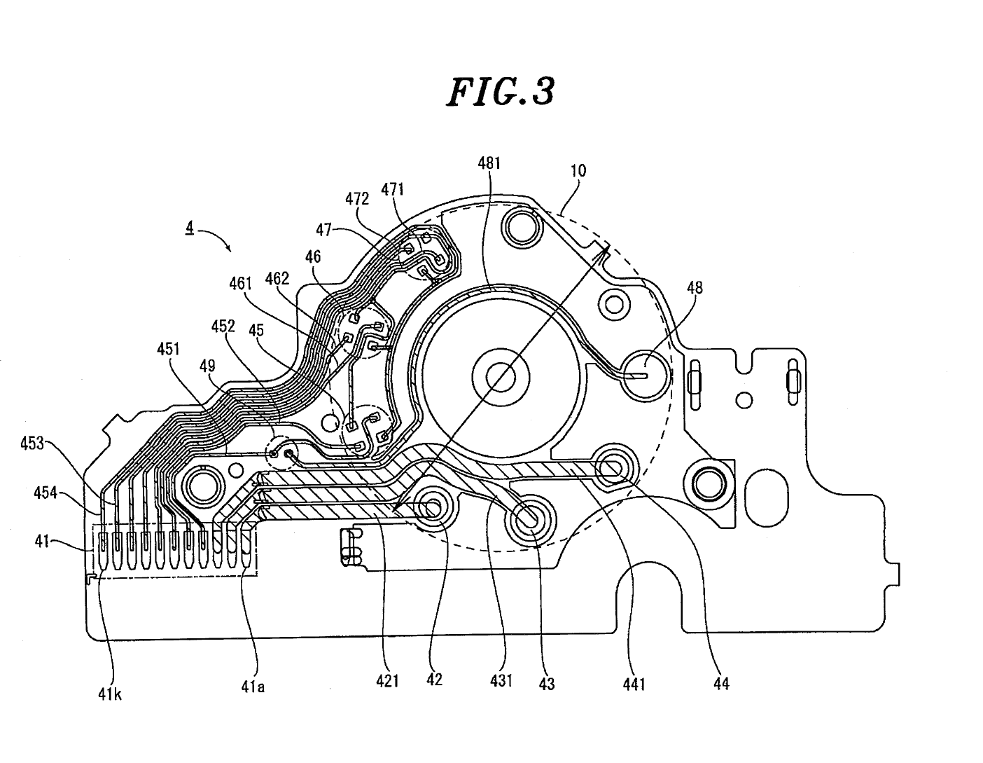

As shown in FIG. 1, a brushless motor 1 is mounted to a printed circuit board for brushless motors 4 (hereinafter simply referred to as a “printed circuit board 4”) and is controlled by means of a control unit 8 connected to wiring lines (see FIGS. 2 and 3) formed in the printed circuit board 4. Hall elements 5 to 7 are also mounted to the printed circuit board 4.

The brushless motor 1 is a three-phase brushless motor and is formed of a rotor magnet 2 and a stator 3. The stator 3 is constructed by winding a U-phase coil 32, a V-phase coil 33 and a W-phase coil 34 around slots of a stator core 31.

The printed circuit board 4 is formed of wiring lines that can adapt themselves to either a magnetic detection method for detecting a magnetic pole position of the rotor magnet 2 or a sensorless method. In other words, depending on the specifications of a product equipped with the brushless motor, the wiring lines of the printed circuit board 4 are switched over to wiring lines corresponding to either the magnetic detection method or the sensorless method.

The U-phase coil 32 is connected at one end to a U-phase coil connection terminal 42 of the printed circuit board 4. Similarly, the V-phase coil 33 and the W-phase coil 34 are connected at one end to a V-phase coil connection terminal 43 and a W-phase coil connection terminal 44 of the printed circuit board 4. The U-phase coil 32, the V-phase coil 33 and the W-phase coil 34 are connected at the other end to a neutral point connection terminal 48 of the printed circuit board 4. Also provided is a connection portion 41 that serves as an interface for electrically interconnecting the wiring lines formed in the printed circuit board 4 and the control unit 8.

The Hall elements 5 to 7 are elements that output hall signals proportional to the magnitude of a magnetic flux density changing with rotation of the rotor magnet 2. The Hall elements 5 to 7 are mounted to the printed circuit board 4 only when the magnetic detection method is used as a method for detecting the magnetic pole position of the rotor magnet 2. This means that the Hall elements 5 to 7 are not mounted to the printed circuit board 4 in case of using the sensorless method as a magnetic pole position detection method.

The control unit 8 detects the magnetic pole position of the rotor magnet 2 to control an electric current supplied to the U-phase coil 32, the V-phase coil 33 and the W-phase coil 34. The control unit 8 includes a detection circuit (not shown) corresponding to one of the magnetic detection method and the sensorless method. For example, if the magnetic detection method is used as a magnetic pole position detection method, the control unit 8 includes a detection circuit that detects the magnetic pole position of the rotor magnet 2 based on the hall signals outputted from the Hall elements 5 to 7. On the other hand, in case of using the sensorless method, the control unit 8 includes a detection circuit that detects the magnetic pole position of the rotor magnet 2 based on a counter-electromotive force generated in one of the U-phase coil 32, the V-phase coil 33 and the W-phase coil 34 and a neutral point voltage. In this regard, the neutral point voltage refers to a voltage developed in the neutral point connection terminal 48, which is the neutral point of the U-phase coil 32, the V-phase coil 33 and the W-phase coil 34.

Now, the wiring lines formed in the printed circuit board 4 will be described with reference to FIG. 2. FIG. 2 is a schematic view showing a circuit that includes the wiring lines formed in the printed circuit board 4 and the individual coils of the brushless motor 1.

The circuit shown in FIG. 2 is presented merely to explain the connection state of the wiring lines formed in the printed circuit board 4 and does not correspond to one of the magnetic detection method and the sensorless method. In the circuit shown in FIG. 2, circuit elements and wiring lines other than the U-phase coil 32, the V-phase coil 33 and the W-phase coil 34 are mounted to or formed in the printed circuit board 4.

First, description will be made regarding the connection portion 41. As can be seen in FIG. 2, eleven terminals are formed in the connection portion 41. These terminals are designated by reference numerals 41a to 41k one after another from the upper side in FIG. 2. The terminals 41a to 41c are connected to the individual coils received within the brushless motor 1. The terminals 41d to 41i serve as output terminals of the hall signals outputted from the Hall elements 5 to 7. The terminals 41j and 41k are used to supply a bias current to the Hall elements 5 to 7.

Next, description will be given on the connection of the U-phase coil 32, the V-phase coil 33 and the W-phase coil 34. The U-phase coil 32 is connected at one end to the terminal 41a via the U-phase coil connection terminal 42 and a U-phase coil connection wiring line 421. The V-phase coil 33 is connected at one end to the terminal 41b via the V-phase coil connection terminal 43 and a V-phase coil connection wiring line 431. The W-phase coil 34 is connected at one end to the terminal 41c via the W-phase coil connection terminal 44 and a W-phase coil connection wiring line 441.

The U-phase coil 32, the V-phase coil 33 and the W-phase coil 34 are connected at the other end to the neutral point connection terminal 48. In other words, the U-phase coil 32, the V-phase coil 33 and the W-phase coil 34 are connected in such a way as to make star-connection in which the neutral point connection terminal 48 constitutes the neutral point. The neutral point connection terminal 48 is connected to the terminal 41d via a neutral point connection wiring line 481, a jumper resistor 491 and a Hall element connection wiring line 451.

Next, description will be made on the connection of the Hall elements 5 to 7. The Hall element 5 will be described first. The Hall element 5 is provided with terminals 5a, 5b, 5c and 5d. The terminals 5a and 5b are used to output the hall signals. The terminals 5c and 5d are used to supply a bias current.

The terminal 5a of the Hall element 5 is connected to the terminal 41d through the Hall element connection wiring line 451. The terminal 5b of the Hall element 5 is connected to the terminal 41e through a Hall element connection wiring line 452. The terminals 5c and 5d are connected to the terminals 41j and 41k through bias current supply wiring lines 453 and 454. Although the terminal 41d is illustrated in FIG. 2 as if it is connected to both the neutral point connection terminal 48 and the terminal 5a of the Hall element 5, the terminal 41d is actually connected to either the neutral point connection terminal 48 or the terminal 5a of the Hall element 5 as will be described later.

The Hall elements 6 and 7 are provided with the same terminals as those of the Hall element 5. Terminals 6a and 6b of the Hall element 6 are connected to the terminals 41f and 41g through Hall element connection wiring lines 461 and 462. Terminals 6c and 6d of the Hall element 6 are connected to the terminals 41j and 41k through the bias current supply wiring lines 453 and 454. Likewise, the terminals 7a and 7b of the Hall element 7 are connected to the terminals 41h and 41i through Hall element connection wiring lines 471 and 472. Terminals 7c and 7d of the Hall element 7 are connected to the terminals 41j and 41k through the bias current supply wiring lines 453 and 454.

In this regard, description will be made regarding a wiring line switching portion 49. The connection state of the neutral point connection wiring line 481 and the Hall element connection wiring line 451 is switched over by means of the wiring line switching portion 49 so that the printed circuit board 4 can adapt itself to one of the magnetic detection method and the sensorless method.

First, description will be made on a case where the magnetic detection method is used as a magnetic pole position detection method. In this case, the jumper resistor 491 of the wiring line switching portion 49 shown in FIG. 2 is not mounted to the printed circuit board 4. In other words, the neutral point connection wiring line 481 and the Hall element connection wiring line 451 are not connected to each other. The Hall elements 5 to 7 are mounted to the printed circuit board 4 so that the printed circuit board 4 can adapt itself to the magnetic detection method. Therefore, a drive current of the brushless motor 1 is inputted and outputted through the terminals 41a to 41c of the connection portion 41 and the hall signals or the bias current is inputted and outputted through the terminals 41d to 41k.

Next, description will be made on a case where the sensorless method is used as a magnetic pole position detection method. The jumper resistor 491 of the wiring line switching portion 49 is mounted to the printed circuit board 4. In other words, the neutral point connection wiring line 481 and the Hall element connection wiring line 451 are connected to each other. The Hall elements 5 to 7 are not mounted to the printed circuit board 4. Therefore, the drive current of the brushless motor 1 is inputted and outputted through the terminals 41a to 41c of the connection portion 41 and the neutral point voltage is outputted through the terminal 41d. At this time, no signal is inputted and outputted through the terminals 41e to 41k of the connection portion 41.

In this manner, the printed circuit board 4 is adapted to either the magnetic detection method or the sensorless method by switching over the connection state of the neutral point connection wiring line 481 and the Hall element connection wiring line 451 with the jumper resistor 491.

Now, the wiring lines formed in the printed circuit board 4 will be described with reference to FIG. 3. FIG. 3 is a plan view showing the printed circuit board 4.

Wiring lines corresponding to the circuit diagram shown in FIG. 2 are formed in the printed circuit board 4 illustrated in FIG. 3. The Hall elements 5 to 7 and the jumper resistor 491 shown in FIG. 2 are not illustrated in FIG. 3. In the connection portion 41 illustrated in FIG. 3, the terminals 41a to 41k are formed sequentially from the right side. On the front side of the printed circuit board 4 in terms of the drawing paper surface, the brushless motor 1 is mounted to a circular area 10 indicated by a broken line in FIG. 3.

First, description will be made on the wiring lines and the terminals formed in the printed circuit board 4. The U-phase coil connection terminal 42, the V-phase coil connection terminal 43 and the W-phase coil connection terminal 44 are formed inside the circular area 10 to which the brushless motor 1 is mounted.

Hall element mounting regions 45 to 47 to which the Hall elements 5 to 7 are mounted are formed inside the circular area 10. Terminals to be connected to the respective terminals of the Hall elements 5 to 7 are formed in the Hall element mounting regions 45 to 47. The Hall element connection wiring lines 451 and 452 and the bias current supply wiring lines 453 and 454 are formed to extend from the terminals 41d, 41e, 41j and 41k to the Hall element mounting region 45. This holds true for the Hall element mounting regions 46 and 47.

The neutral point connection wiring line 481 is formed to extend from the neutral point connection terminal 48 to the wiring line switching portion 49. As illustrated in FIG. 3, the neutral point connection wiring line 481 has a width greater than that of the Hall element connection wiring line 451 or the like but smaller than that of the U-phase coil connection wiring line 421 or the like. The width of the wiring lines noted above are decided by the intensity of an electric current flowing through the individual wiring lines.

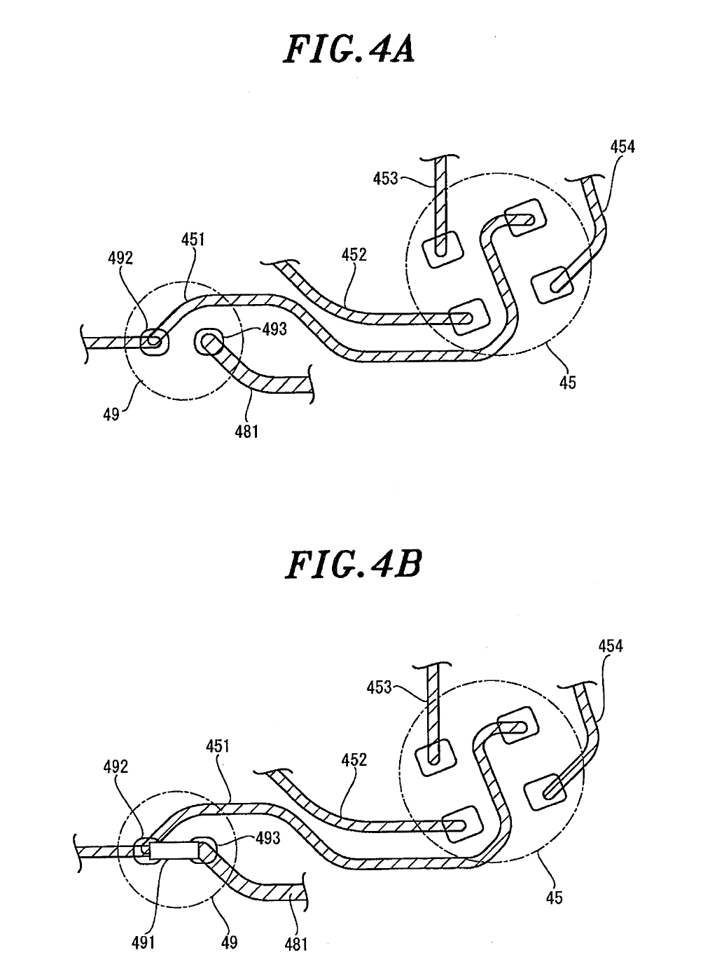

In this connection, the wiring line switching portion 49 will be described with reference to FIGS. 3 and 4. FIG. 4A is an enlarged view illustrating the Hall element mounting region 45 and the surrounding region of the wiring line switching portion 49 of the printed circuit board 4 illustrated in FIG. 3. FIG. 4B is a view depicting a state that the jumper resistor 491 is mounted to the wiring line switching portion 49.

The wiring line switching portion 49 is formed outside the circular area 10 as illustrated in FIG. 3. The reason is follows. In order to reduce the size of a disk drive apparatus equipped with the brushless motor 1, it is generally necessary to reduce the axial dimension of the brushless motor 1 including the printed circuit board 4 (i.e., the dimension in a vertical direction in FIG. 1, which will be simply referred to as an “axial dimension” hereinbelow). For this reason, the rotor magnet 2 and the stator 3 are installed as close to the printed circuit board 4 as possible. If the wiring line switching portion 49 is formed inside the circular area 10, however, it becomes necessary to mount the jumper resistor 491 between the printed circuit board 4 and the rotor magnet 2 and the stator 3. As a result, the axial dimension is increased in proportion to the size of the jumper resistor 491. Therefore, the wiring line switching portion 49 is formed outside the circular area 10 in an effort to keep the axial dimension as small as possible.

Next, description will be made on a wiring state of the wiring line switching portion 49. Referring to FIG. 4A, the wiring line switching portion 49 includes a wiring line switching terminal 492 formed in the Hall element connection wiring line 451. The wiring line switching portion 49 further includes an end terminal 493 formed in the neutral point connection wiring line 481 in a facing relationship with the wiring line switching terminal 492.

In case of using the magnetic detection method as a magnetic pole position detection method, the wiring line switching terminal 492 and the end terminal 493 are not connected to each other as can be seen in FIG. 4A. On the other hand, in case of using the sensorless method, the wiring line switching terminal 492 and the end terminal 493 are connected to each other through the jumper resistor 491 as can be seen in FIG. 4B. This allows the neutral point voltage to be outputted from the terminal 41d of the connection portion 41.

As illustrated in FIG. 4A, the wiring lines corresponding to the magnetic detection method are initially formed in the wiring line switching portion 49. In case of adapting the printed circuit board 4 to the sensorless method, the wiring line switching terminal 492 and the end terminal 493 are connected to each other through the jumper resistor 491. This ensures that the neutral point voltage outputted from the neutral point connection wiring line 481 is prevented from being inputted to the Hall element connection wiring line 451 in case of using the magnetic detection method.

As set forth above, the printed circuit board 4 of the present embodiment includes the Hall element connection wiring lines 451, 452, 461, 462, 471 and 472 and the bias current supply wiring lines 453 and 454 for use in the magnetic detection method and the neutral point connection wiring line 481 for use in the sensorless method. Furthermore, the wiring line switching terminal 492 of the Hall element connection wiring line 451 and the end terminal 493 of the neutral point connection wiring line 481 are formed in the printed circuit board 4 in an electrically connectable state. In case of using the sensorless method, the wiring line switching terminal 492 and the end terminal 493 of the wiring line switching portion 49 are connected to each other by means of the jumper resistor 491. This makes it possible for a single printed circuit board to adapt itself to either the magnetic detection method or the sensorless method. Therefore, it is possible to assure increased efficiency and reduced cost when designing and prototyping the printed circuit board for brushless motors.

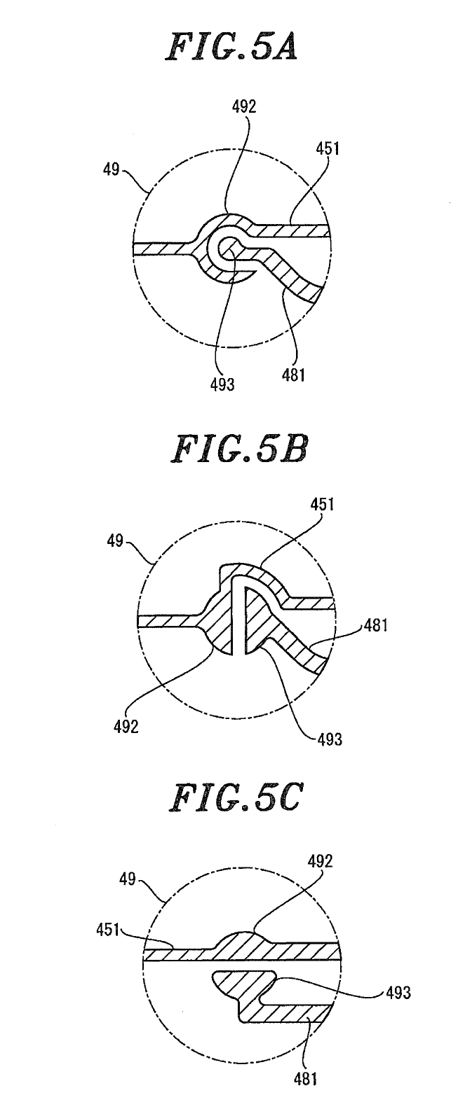

Although the wiring line switching terminal 492 and the end terminal 493 in the wiring line switching portion 49 are connected to each other by means of the jumper resistor 491 in case of using the sensorless method as a magnetic pole position detection method, the present invention is not limited thereto. For example, cream solder (not shown) or the like may be used in place of the jumper resistor 491. This helps reduce the number of parts employed in the printed circuit board 4. In case the cream solder is used in the wiring line switching portion 49, it is preferred that the wiring line switching terminal 492 and the end terminal 493 be formed in such a pattern as to face toward each other with an increased length. This makes it possible to reduce contact failure of the cream solder with the wiring line switching terminal 492 and the end terminal 493. For example, the wiring line switching terminal 492 and the end terminal 493 may be formed in the patterns as illustrated in FIGS. 5A to 5C.

Furthermore, although the wiring line switching terminal 492 of the Hall element connection wiring line 451 and the end terminal 493 of the neutral point connection wiring line 481 are connected to each other in the above description, the present invention is not limited thereto. Alternatively, the neutral point connection wiring line 481 may be connected to other Hall element connection wiring lines. In other words, the neutral point voltage may be outputted from one of the terminals 41d to 41i of the connection portion 41 that output the hall signals. The Hall element connection wiring line connected to the neutral point connection wiring line 481 may be decided depending on the shape of the printed circuit board 4, the wiring line pattern formed in the printed circuit board 4, the arrangement of the terminals formed in the connection portion 41, and so forth.

In addition, although the Hall elements are used in the magnetic detection method according to the present embodiment, the present invention is not limited thereto. As an alternative example, MR sensors may be used in place of the Hall elements.

While the invention has been shown and described with respect to the embodiment, it will be understood by those skilled in the art that various changes and modifications may be made without departing from the scope of the invention as defined in the following claims.

What is claimed is:

1. A printed circuit board for a brushless motor comprising:
a connection portion connectable to a control unit for driving the brushless motor;
a plurality of position detection element connection wiring lines respectively extending from a plurality of installation places of position detection elements to the connection portion, the position detection elements detecting a magnetic pole position of a rotor magnet of the brushless motor;
a wiring line switching portion for switching over a connection state between a specific one of the position detection element connection wiring lines and another wiring line; and
a neutral point connection wiring line extending from a neutral point to the wiring line switching portion, the brushless motor having a plurality of coils connected at one end to the neutral point,
wherein the specific one of the position detection element connection wiring lines and the neutral point connection wiring line are connectable to each other by means of a conductor in the wiring line switching portion.

2. The printed circuit board of claim 1, wherein, if the position detection elements are mounted to the installation places, the specific one of the position detection element connection wiring lines and the neutral point connection wiring line are not connected to each other in the wiring line switching portion.

3. The printed circuit board of claim 1, wherein, if the position detection elements are not mounted to the installation places, the specific one of the position detection element connection wiring lines and the neutral point connection wiring line are connected to each other by means of the conductor in the wiring line switching portion.

4. The printed circuit board of claim 3, wherein the conductor is a jumper resistor.

5. The printed circuit board of claim 3, wherein the conductor is solder.

6. The printed circuit board of claim 1, wherein the position detection elements are Hall elements.

7. The printed circuit board of claim 1, wherein the neutral point connection wiring line has a width greater than that of each of the position detection element connection wiring lines but smaller than that of a power source connection wiring line connected to the brushless motor.

8. The printed circuit board of claim 1, wherein the wiring line switching portion is arranged radially outwardly of the rotor magnet.

9. A brushless motor connected to the printed circuit board of claim 1.
